(19) United States
(12) Patent Application Publication
(10) Pub. No.: US 2007/0056551 A1
(43) Pub. Date: Mar. 15, 2007

(54) Transmission shaft support mechanism

(75) Inventors: Masahiko Nakatsuka, Saitama (JP); Daisuke Kubota, Saitama (JP); Masaki Cho, Saitama (JP); Takanori Osuka, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD.

(21) Appl. No.: 11/518,147

(22) Filed: Sep. 11, 2006

(30) Foreign Application Priority Data
Sep. 14, 2005 (JP) 2005-267382

(51) Int. Cl. F16H 57/04

(52) U.S. Cl. 123/197.1; 475/159

(57) ABSTRACT

To provide a transmission shaft support mechanism, which includes a power unit case that contains a lubricating oil supply mechanism, and a gear shaft that supports a group of gears for power transmission. An intermediate shaft holder is contained in the power unit case for supporting an intermediate shaft having an idle gear so as to be attached to an intermediate shaft holder attachment surface formed on an inner wall of the power unit case such that the lubricating performance for the intermediate shaft is improved and the lubricating mechanism is simplified. Bolt holes are formed in the intermediate shaft holder and the intermediate shaft holder attachment surface. The oil supply passage for lubricating the intermediate shaft is formed along the bolt holes.

### CROSS-REFERENCE TO RELATED APPLICATIONS

The present application claims priority under 35 USC 119 to Japanese Patent Application No. 2005-267382 filed on Sep. 15, 2005 the entire contents of which are hereby incorporated by reference.

### BACKGROUND OF THE INVENTION

1. Field of the Invention

The present invention relates to a transmission shaft support mechanism. More specifically, to an improvement for a mechanism for supplying oil to an intermediate shaft that supports an idle gear.

2. Background of the Invention

A generally employed intermediate shaft support portion is structured to lead lubricating oil droplets into the shaft through an opening formed in the upper surface of the intermediate shaft. See, for example, JP-B No. S62-39301, FIG. 4. The aforementioned structure causes a difficulty by increasing the lubricating oil supplied to the intermediate shaft.

### SUMMARY AND OBJECTS OF THE INVENTION

It is an object of an embodiment of the present invention to provide a transmission shaft support mechanism for improving the performance for lubricating the intermediate shaft and simplifying the lubricating structure.

An embodiment of the present invention addresses the aforementioned problem by providing a transmission shaft support mechanism which includes a lubricating oil supply mechanism and a gear shaft for supporting a group of gears for power transmission contained therein. An intermediate shaft holder is provided that supports an intermediate shaft. Bolt holes are formed in the intermediate shaft holder and an attachment surface of the intermediate shaft holder of the power unit case such that an oil supply passage for lubricating the intermediate shaft is formed along the bolt holes.

An embodiment of the present invention provides a power unit case that includes a journal bearing for supporting a crankshaft. A main gallery for supplying oil to the journal bearing is provided at a side of the gear shaft of a cylinder to extend toward the crankshaft. The intermediate shaft holder is provided between the journal bearing and the gear shaft with a branch oil passage being formed to supply oil from the main gallery to the intermediate shaft holder.

An embodiment of the present invention provides an orifice member having an oil passage formed therein that is interposed between abutting surfaces of the power unit case and the intermediate shaft holder.

An embodiment of the present invention provides an intermediate shaft holder that is provided at a lower portion of a rotating member including the crankshaft with a recess portion in its upper surface for trapping and retaining oil droplets.

In an embodiment of the present invention, the oil supply passage for the intermediate shaft is formed to be parallel with the connecting bolt hole. The bolt holes may be formed through an easy process, for example, punching or drilling from the same direction.

In an embodiment of the present invention, as the branch fuel passage for supplying the oil to the intermediate shaft holder may be made short, the lubricating performance for the gear shaft is improved.

In an embodiment of the present invention, as the oil is distributed from the main gallery of the power unit case into the intermediate shaft holder via the orifice member, the oil pressure in the main gallery is not decreased to be excessively low. This makes it possible to obtain a sufficient quantity of oil to be supplied to the journal bearing of the crankcase.

In an embodiment of the present invention, the intermediate shaft holder is disposed at the lower portion of the rotating member such as the crankshaft such that the oil droplets are trapped and retained in the recess portion. The oil retained in the recess portion may be supplied into the lower gear as the lubricating oil through the vibration or inclination upon start-up of the engine. This makes it possible to improve the initial lubricating performance.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a top view of a motorcycle 1 with a sidecar according to a first embodiment of the present invention;

FIG. 2 is a cross section of a power unit 3 of the motorcycle 1 seen from backward, representing a cross section of a portion around a reverse transmission gear;

FIG. 3 is a view of the left half portion 10L of the power unit case seen from the inside;

FIG. 4 is a cross-sectional development view including axes of the left cylinder 13, the crankshaft 22, and the main shaft 30 of the transmission;

FIG. 5 is a view obtained by modifying the cross-sectional development view including the main shaft 30, the counter shaft 31 and the output shaft 65 of the transmission, and the cross-sectional development view including the support shaft 32 of the shift fork and the shift drum 33 so as to be matched with respect to the axial position;

FIGS. 6(a)-6(h) represent views of the intermediate shaft holder 37, which includes FIG. 6(a) as a top view of the intermediate shaft holder 37, FIG. 6(b) as a view of FIG. 6(a) seen from an arrow B, FIG. 6(c) as a view of FIG. 6(a) seen from an arrow C, FIG. 6(d) as a view of FIG. 6(a) seen from an arrow D, FIG. 6(e) as a sectional view taken along line I-I of FIG. 6(a), FIG. 6(f) as a sectional view taken along line II-II of FIG. 6(a), FIG. 6(g) is a sectional view taken along line III-III of FIG. 6(a), and FIG. 6(h) as a sectional view taken along line IV-IV of FIG. 6(a);

FIG. 7 is a sectional view of the portion around the journal bearing 40;

FIG. 8 is a sectional view of the fuel supply passage to the intermediate shaft 34; and

FIG. 9 is a front view of the left half portion 10L of the power unit case shown in FIG. 3.

### DETAILED DESCRIPTION OF THE PREFERRED EMBODIMENTS

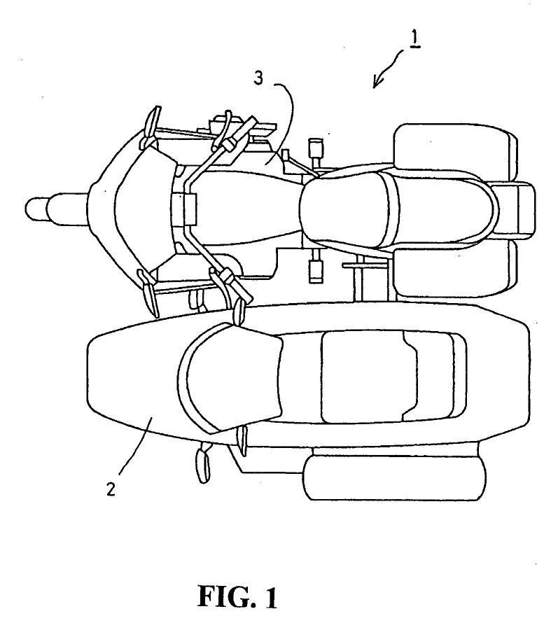

FIG. 1 is a top view of a motorcycle 1 with a sidecar as an embodiment of the present invention. The motorcycle 1 combined with a sidecar 2 at one side has a power unit 3 installed at its center. The motorcycle 1 with the sidecar is shown as an example of the vehicle provided with a reverse transmission gear.

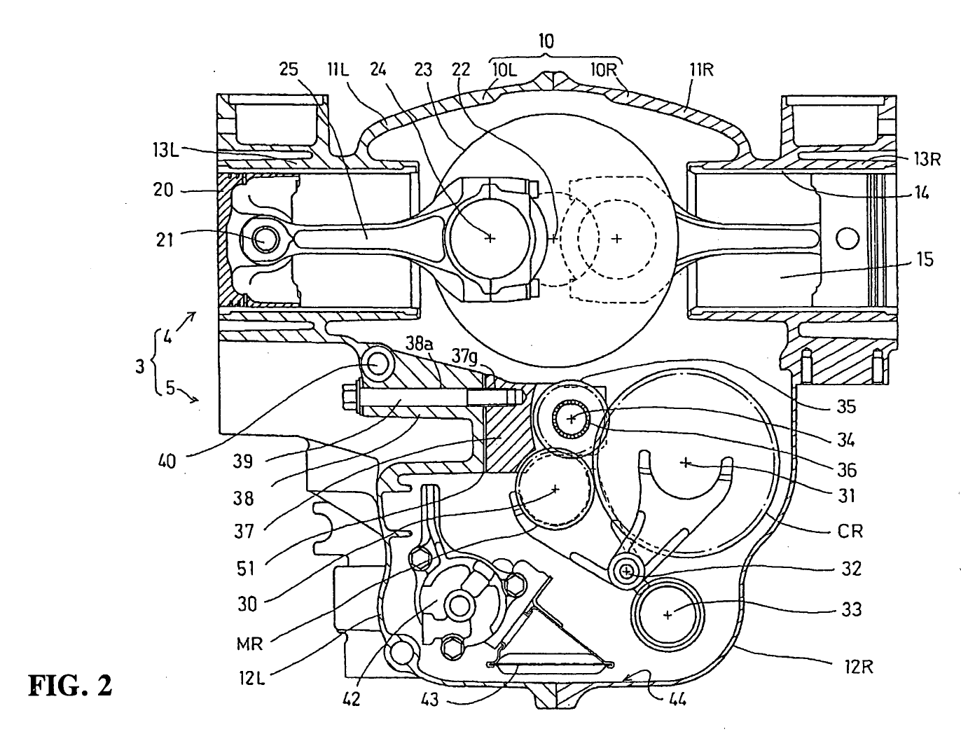

FIG. 2 is a sectional view of the power unit 3 around the reverse transmission gear. The power unit 3 includes a horizontal opposed type 6-cylinder internal combustion engine 4 including three cylinders at both sides respectively, and a transmission 5 provided with four forward stages and one reverse stage formed at the lower portion of the internal combustion engine. Referring to FIG. 2, a crankcase 11 forms the upper half portion of a power unit case 10, and a transmission case 12 forms the lower half portion thereof. Cylinders 13 are provided at both sides of the crankcase 11. The aforementioned portions are combined to form the power unit case 10. Cylinder heads and cylinder head covers attached to the left and right end portions of the cylinder 13 are not shown in FIG. 2.

The power unit case 10 is divided into left and right half portions 10L and 10R. Each half section of the aforementioned three portions 11, 12, and 13 is integrally disposed in each of the left and right half portions 10L and 10R, respectively. That is, left half portions 11L, 12L and 13L of the crankcase, transmission case, and the cylinder integrally form the left half portion 10L of the power unit case, and right half portions 11R, 12R and 13R of the crank case, transmission case, and cylinder integrally form the right half portion 10R of the power unit case, respectively. The crankcase 11 is formed by combining the left and right half portions 11L and 11R. The transmission case 12 is formed by combining the left and right half portions 12L and 12R. In the case where the left and right portions do not have to be distinguished for making a general explanation, the reference code “L” or “R” may be omitted.

A cylinder liner 14 is applied to the inner surface of the cylinder 13. A piston 20 is slidably inserted into a cylinder hole 15 formed in the cylinder 13. A crankshaft 22 and a crank web 23 are rotatably provided at the center of the crankcase 11. A piston pin 21 of the piston 20 is connected to a crank pin 24 of the crankshaft 22 via a connecting rod 25 with end portions each rotatable with respect to the respective pins such that the crankshaft 22 rotates accompanied with the reciprocating movement of the piston 21.

A plurality of shafts for the transmission and other rotating shafts are provided within the transmission case 12. A main shaft 30 of the transmission 5 is interposed between abutting surfaces of the left and right half portions 10L and 10R. The right half portion 10R of the power unit is provided with a counter shaft 31, a shift fork support shaft 32, and a shift drum 33 in parallel with the main shaft 30. An intermediate shaft 34 is supported at an intermediate shaft holder 37 around the portion between the abutting surfaces of the left and right half portions 10L and 10R so as to rotatably support a reverse idle gear 35 via a needle bearing 36. The gear shown in FIG. 2 represents a reverse gear train in the state where a reverse drive gear MR formed on the main shaft 30 is in mesh with a reverse driven gear CR formed on the counter shaft 31 via the idle gear 35, which will be described later. The intermediate shaft 34 is fixed to the intermediate shaft holder 37 that is fixed to an intermediate shaft holder attachment base 38 formed in the half portion 10L of the power unit via a shim 51 with a bolt 39. The shim 51 is used for adjusting a backlash of the reverse train gear.

A main gallery 40 is formed in the left half portion 10L of the power unit. An oil pump 42 for supplying oil to the main gallery 40 and the like, an oil strainer 43, and an oil pan 44 are disposed at a lower portion of the transmission case 12.

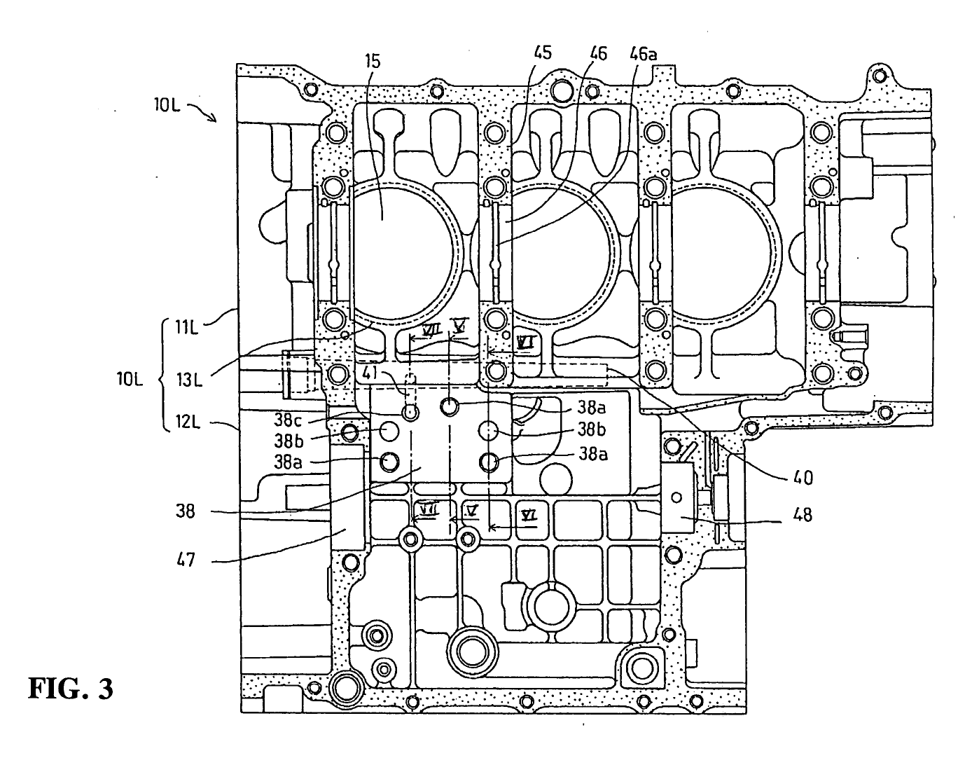

FIG. 3 is a view of the left half portion 10L of the aforementioned power unit seen from inside. The upper half portion forms the left half portion 11L of the crankcase, and the lower half portion forms the left half portion 12L of the transmission case. The drawing shows three cylinders 13L and cylinder holes 15 in alignment. Partition walls 45 are provided at both sides of the cylinders 13L and at positions between adjacent cylinders 13L, respectively. Journal bearings 46, each provided with an oil passage 46a, are formed in the partition walls 45. The same journal bearings 46 as those for the left half portion 10L are formed in the right half portion 10R as well. The thus formed four journal bearings support the crankshaft 22.

The transmission case 12L is provided with a ball bearing holding portion 47 that supports the main shaft 30 for the transmission, and a needle bearing holding portion 48. Like the transmission case 12L, the transmission case 12R is provided with the ball bearing holding portion 47 and the needle bearing holding portion 48 so as to support the main shaft 30. The main gallery 40 (indicated by the dotted line in the drawing) is provided at the transmission shaft side of the cylinder arrangement. An intermediate shaft holder attachment base 38 is formed on the inner surface the transmission case 12L.

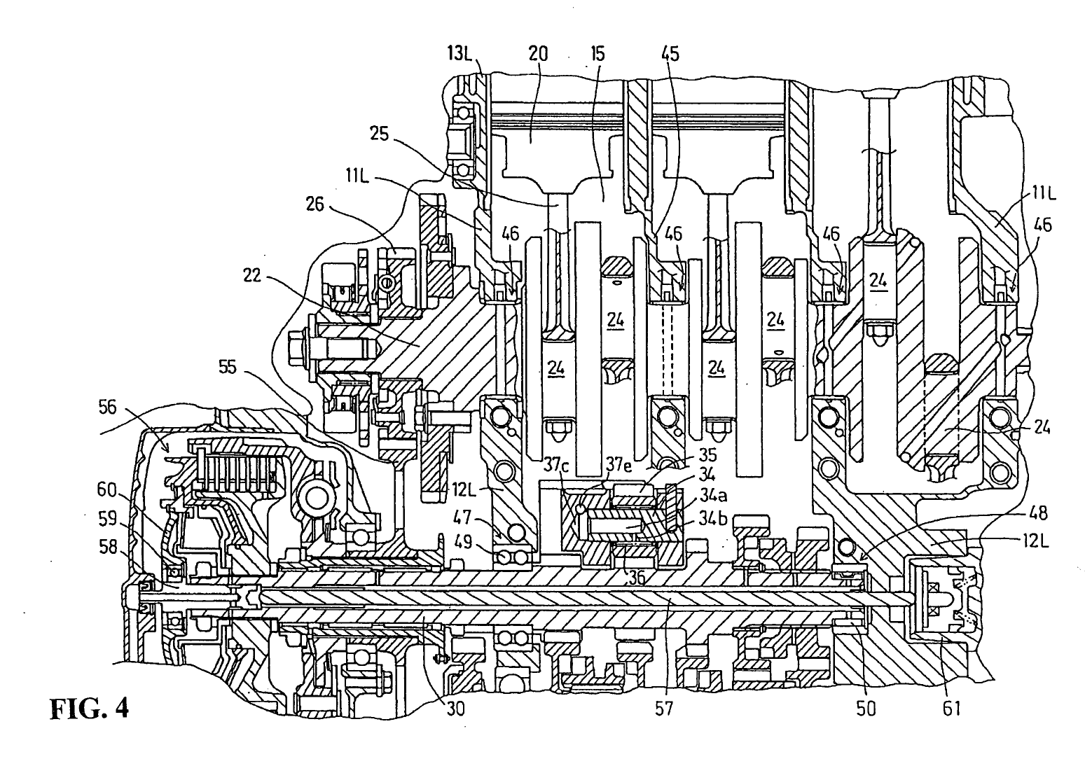

FIG. 4 is a cross-sectional development view including axes of the left cylinder 13, the crankshaft 22, and the main shaft 30 of the transmission, respectively. The crankshaft is rotatably supported at the crankcase 11 and the partition wall 45 via the journal bearings 46 at four points. Crank pins 24 are provided in the crank shaft 22 at six points, which are alternately connected to the connecting rods 25 continued into the left and right pistons 20. A crank shaft output gear 26 is provided at the left end portion of the crankshaft 22.

The main shaft 30 of the transmission is disposed at the lower portion of the crankshaft 22. The main shaft 30 has its one end supported at a ball bearing holding portion 47 of the transmission cases 12L and 12R via a ball bearing 49, and the other end supported at a needle bearing holding portion 48 of the transmission cases 12L and 12R via a needle bearing 50. An input gear 55 for transmission, normally in mesh with the output gear 26 of the crankshaft, is rotatably mounted on the main shaft 30. A multiplate clutch 56 is engaged adjacent to the transmission input gear 55. In the normal state, the rotation of the transmission input gear 55 driven by the crankshaft output gear 26 is transferred to the main shaft 30 via the multiplate clutch 56.

A push rod 57 is inserted into a center hole of the main shaft 30 so as to be slidably moveable in the axial direction. The push rod 57 has a left end extending to a lifter pin 58. The lifter pin 58 is connected to a lifter 60 via a ball bearing 59, and a right end of the push rod 57 abuts on a push rod drive mechanism 61. When the drive mechanism 61 is operated by an operator of the vehicle, the push rod 57 is pushed leftward to move the lifter 60 via the lifter pin 58 and the ball bearing 59. Thus, the engagement of the multiplate clutch 56 is released.

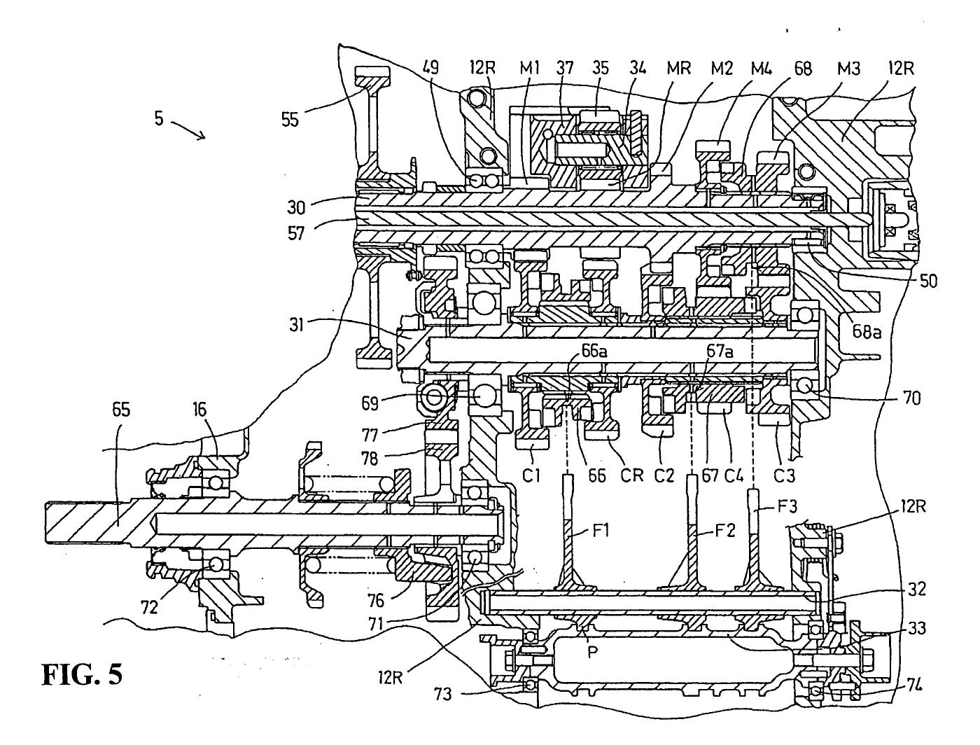

FIG. 5 is a view obtained by modifying the cross-sectional development view showing the main shaft 30, the counter shaft 31, and an output shaft 65 of the transmission 5, and the cross-sectional development view showing the shift fork support shaft 32 and the shift drum 33 so as to be matched with respect to the position in the axial direction. The counter shaft 31 is supported at the right transmission case 12R via the ball bearings 69 and 70. The output shaft 65 has its one end supported at the right transmission case 12R with the ball bearing 71, and the other end rotatably supported at the transmission cover 16 via the ball bearing 72. The shift fork support shaft 32 is fixed to the right transmission case 12R, and the shift drum 33 is supported at the right transmission case 12R via the ball bearings 73 and 74.

The main shaft 30 is provided with first to fourth forward drive gears M1, M2, M3 and M4, and a reverse drive gear MR. The counter shaft is provided with first to fourth forward driven gears C1, C2, C3 and C4 normally in mesh with the aforementioned forward drive gears, and a reverse driven gear CR normally in mesh with the reverse drive gear MR via the idle gear 35. The aforementioned gears may be divided into three types, that is, type (X) including M1, M2, and MR fixed to the shaft, type (Y) including C1, C2, C3, M4, and CR rotatable with respect to the shaft (immobilized in the axial direction), and type (Z) including M3 and C4 moveable in the axial direction (not rotatable about the axis).

The gear of type (Y), that is rotatable with respect to the shaft, is fixed to the shaft only when it is required to work for power transmission. For this gear, slidable engagement members 66, 67, and 68 are provided that are slidable in the axial direction but not rotatable with respect to the shaft. The slidable engagement member 66 is provided between the driven gears C1 and CR, the slidable engagement member 67 is provided between the driven gears C2 and C3. The slidable engagement member 68 is provided adjacent to the drive gear M4. The axially moveable gear C4 is provided on the outer periphery of the slidable engagement member 67, and the axially moveable gear M3 is provided on the outer periphery of the slidable engagement member 68. The slidable engagement members 66, 67, and 68 are provided with annular channels 66a, 67a, and 68a, respectively each being engaged with the shift fork described later on the outer periphery.

The shift fork support shaft 32 is provided with shift forks F1, F2, and F3 so as to be slidable in the axial direction. The shift fork F1 is engaged with the annular channel 66a of the slidable engagement member 66 of the counter shaft 31. The shift fork F2 is engaged with the annular channel 67a of the slidable engagement member 67 of the counter shaft 31, and the shift fork F3 is engaged with the annular channel 68a of the slidable engagement member 68 of the main shaft 30, respectively. Pins P provided in boss portions of the respective shift forks are engaged with guide grooves of the shift drum such that any one of the shift forks is allowed to selectively move any one of the slidable engagement members in the axial direction in response to the gear shifting operation of an operator of a vehicle. With respect to the reverse gear train, non-rotating slidable engagement member 66 moves rightward together with the shift fork F1 so as to be engaged with the rotatable reverse driven gear CR. The reverse driven gear CR is fixed to the shaft such that the power transmission from the main shaft 30 to the counter shaft 31 is allowed. The gear stage is then switched to the reverse stage.

In the state where the power transmission and gear shifting have been performed as described above, and the neutral drive selector clutch 76 is in the engagement state, the driving force applied to the counter shaft 31 is transmitted to the output shaft 65 via the gear 77 at the left end of the counter shaft, and the gear 78 at the right end of output shaft.

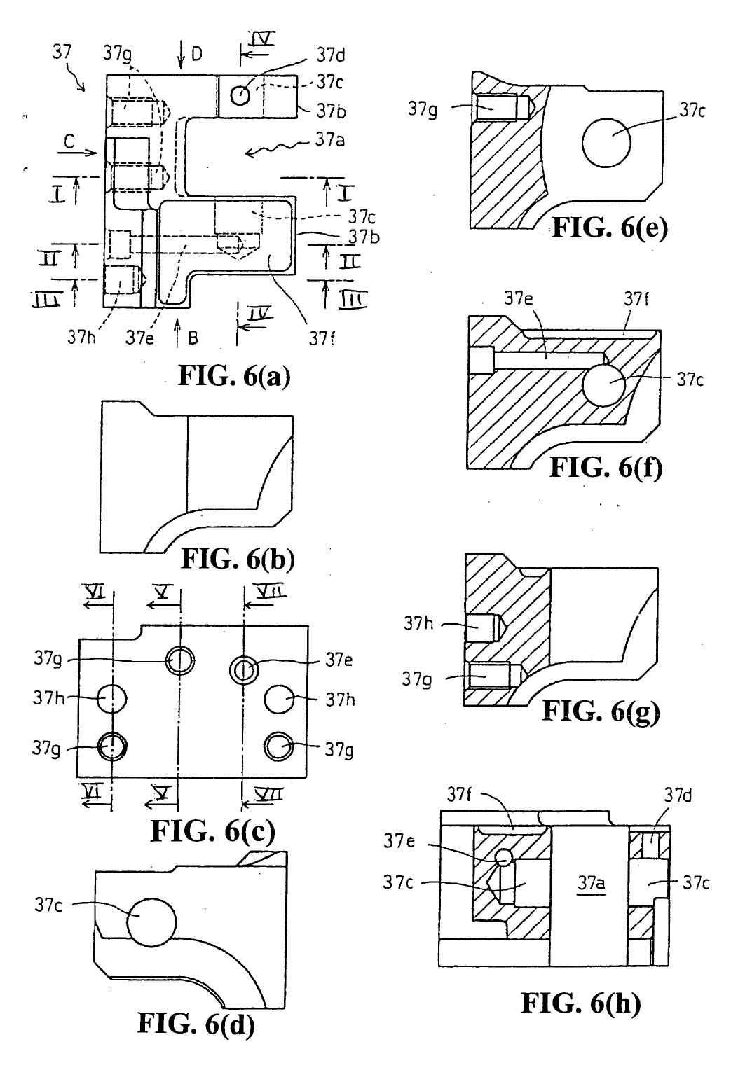

FIGS. 6(a)-6(h) represent views of the intermediate shaft holder 37, which includes FIG. 6(a) as a top view of the intermediate shaft holder 37, FIG. 6(b) as a view of FIG. 6(a) seen from an arrow B, FIG. 6(c) as a view of FIG. 6(a) seen from an arrow C, FIG. 6(d) as a view of FIG. 6(a) seen from an arrow D, FIG. 6(e) as a sectional view taken along line I-I of FIG. 6(a), FIG. 6(f) as a sectional view taken along line II-II of FIG. 6(a), FIG. 6(g) is a sectional view taken along line III-III of FIG. 6(a), and FIG. 6(h) as a sectional view taken along line IV-IV of FIG. 6(a).

Referring to the top view in FIG. 6(a), the left side of the intermediate shaft holder 37 is to be attached to the intermediate shaft holder attachment base 38, and has a large recess portion 37a at the right side toward the center for accommodating the idle gear 35 such that a pair of arm portions 37b extend at both sides. Each of the arm portions 37b has an intermediate shaft hole 37c. One of the arm portions 37b has a pin hole 37d for fixing the intermediate shaft. The other arm portion 37b has an oil supply passage 37e that extends from the left attachment surface to the intermediate shaft hole 37c. A recess portion 37f for trapping oil droplets is formed in the upper surface of the arm having the oil supply passage 37e formed therein. In other views of FIG. 6(a)-6(h), the portions corresponding to the respective portions shown in FIG. 6(a) are designated with the same reference numerals. The recess portion 37f for trapping the oil droplets serves to receive the oil that drops from the crankshaft. Thus, the trapped and retained oil is dropped downward to the gears owing to vibration or inclination upon start-up of the engine for lubricating the gears.

The view FIG. 6(c) shows the attachment surface of the intermediate shaft holder 37, which abuts against the intermediate shaft holder attachment base 38. The attachment surface has three screw holes 37g, and two dowel pin holes 37h for positioning. The connecting portion of the oil supply passage 37e toward the intermediate shaft is shown. In other views of FIG. 6(a)-6(h), the portions corresponding to the respective portions shown in FIG. 6(c) are designated with the same reference numerals.

FIG. 3 shows the intermediate shaft holder attachment surface of the intermediate shaft holder attachment base 38. Three attachment bolt holes 38a corresponding to the screw holes 37g formed in the intermediate shaft holder 37, and two dowel pins 38b corresponding to the dowel pin holes 37h for positioning of the intermediate shaft holder are formed. The connecting hole 38c of a branch fuel passage 41 that extends from the main gallery 40 to the intermediate shaft holder 37 is formed at the position corresponding to the connecting portion of the oil supply passage 37e.

Positions of the three attachment bolt holes 38a formed in the intermediate shaft holder attachment surface of the intermediate shaft holder attachment base 38 and relative space thereamong shown in FIG. 3, and the arrangement of the screw holes 37g formed in the attachment surface of the intermediate shaft holder 37 in abutment against the intermediate shaft holder attachment surface of the base 38 shown in FIG. 6(c) and relative space therebetween have been set such that they are distributed both in the vertical and lateral directions with sufficient space for stabilizing the tightening force applied to the bolt 39 to be tightened outside the crankcase as well as forming the oil supply passage 37e to the intermediate shaft.

The intermediate shaft holder 37 and the intermediate shaft holder attachment base 38 in FIG. 2 are represented by the sectional views taken along the line V-V of FIG. 6(c), and V-V of FIG. 3. There are three bolts 39 inserted into the bolt holes 38a of the intermediate shaft holder base 38 so as to be screwed into the screw holes 37g of the intermediate shaft holder 37 such that the intermediate holder 37 is assembled with the base 38. FIG. 2 shows one of those bolts.

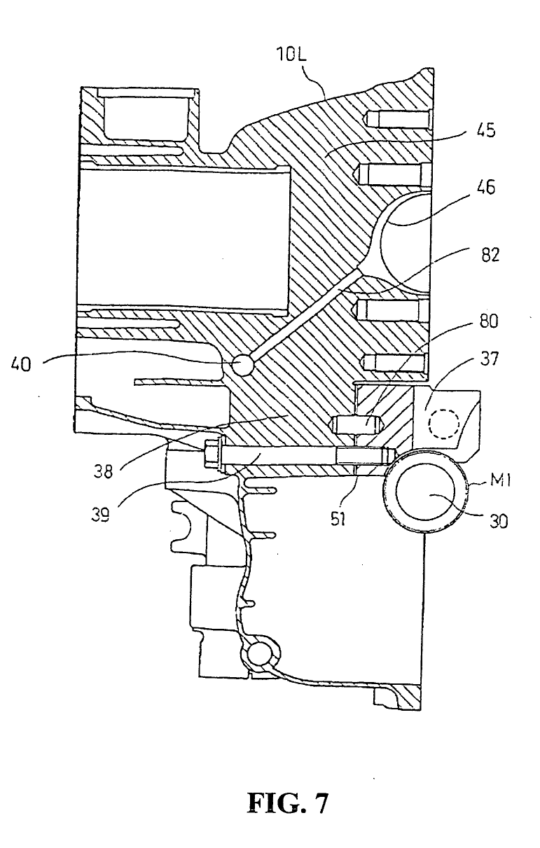

FIG. 7 is a sectional view showing a portion around the journal bearing 40. The intermediate holder 37 and the intermediate shaft holder attachment base 38 in the drawing are represented by the sectional views taken along the line VI-VI of FIG. 6(c) and the line VI-VI of FIG. 3. The intermediate shaft holder 37 is assembled with the base 38 using the dowel pins 80 and the bolts 39. An oil passage 82 is formed in the partition wall 45 from the main gallery 40 to the journal bearing 46 so as to lubricate the rotatable sliding portion of the crankshaft 22.

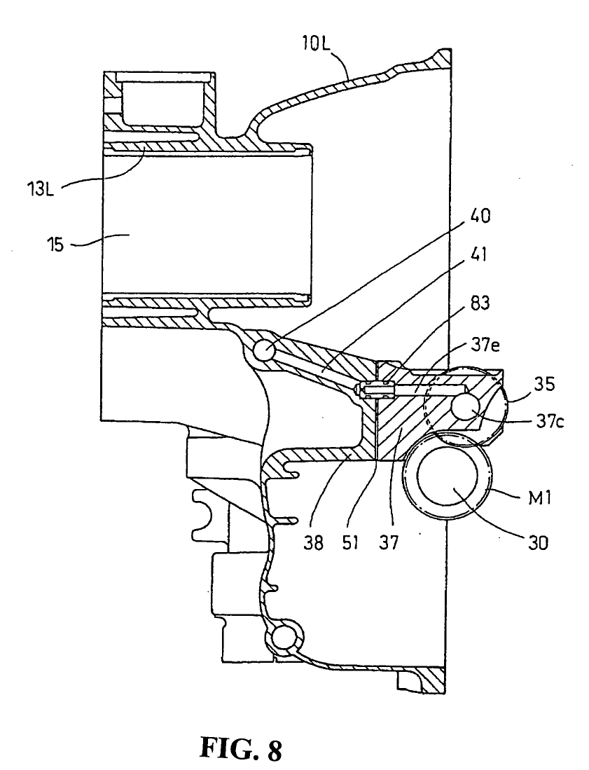

FIG. 8 is a sectional view of the oil supply passage toward the intermediate shaft 34. The intermediate holder 37 and the intermediate holder attachment base 38 in the drawing are represented by the sectional views taken along the line VII-VII of FIG. 6(c) and the line VII-VII of FIG. 3. FIG. 8 shows the oil supply passage 37e within the intermediate shaft holder 37, and the branch oil passage 41 extending from the main gallery 40 to the intermediate shaft holder 37. The branch oil supply passage 41 is connected to the oil supply passage 37e via a connecting member 83 with an orifice. The lubricating oil is fed from the main gallery 40 into the oil supply passage 37e of the intermediate shaft holder 37 as shown in FIG. 8. The lubricating oil is fed to the end space of the intermediate shaft hole 37c of the intermediate shaft holder 37 as shown in FIG. 4 to be supplied to the center hole 34a of the intermediate shaft 34 and the needle bearing 36 that supports the idle gear 35 via the radial hole 34b communicated therewith so as to be lubricated. This allows the idle gear 35 to smoothly rotate.

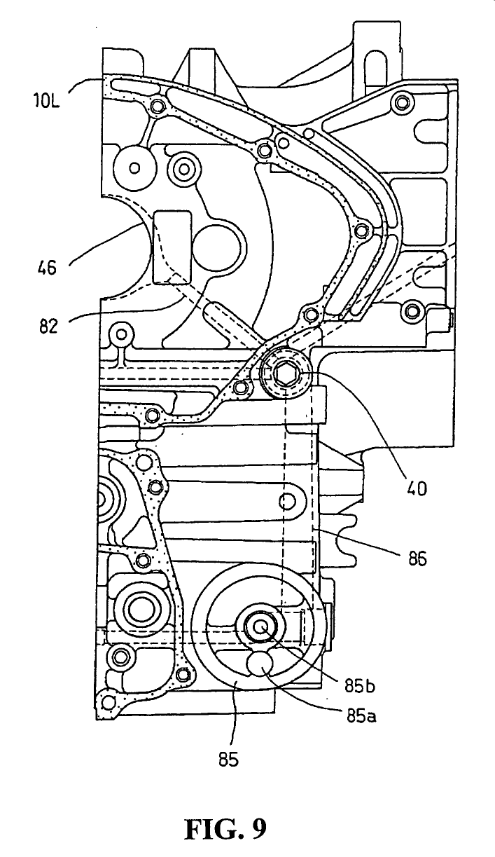

In FIG. 9 is a front view of the left half portion 10L of the power unit case shown in FIG. 3 wherein passages through which the lubricating oil is supplied to the main gallery 40 are indicated by the dashed line. The lubricating oil is supplied from the oil pump 42 shown in FIG. 2 toward an oil inlet 85a of an oil filter 85 shown in FIG. 9 via a not shown oil passage. The lubricating oil that has been purified through the oil filter 85 is discharged through an oil outlet 85b (far side of the drawing) so as to be fed to the main gallery 40 via the vertical oil passage 86. The lubricating oil is fed from the main gallery 40 to the journal bearing 46 and the other points to be lubricated via the oil passage 82.

The present embodiment provides the effects as described below.

As the oil supply passage 37e for supplying the oil to the intermediate shaft is formed in the intermediate shaft holder 37 in parallel with the screw hole 37g for attachment to the intermediate shaft holder attachment base 38, the holes may be formed through an easy process such as punching and drilling.

(2) As the oil passage for supplying the oil to the intermediate shaft holder has the branch oil passage 41 from the main gallery 40, the length of the oil passage for supplying the oil to the intermediate shaft holder 37 may be made short, and as a result, the lubricating performance for the gear shaft is improved.

As the connecting portion of the branch oil passage 41 is provided with the orifice member 83 so as to be connected from the main gallery 40 to the intermediate shaft holder 37, the oil pressure in the main gallery 40 does not fall to an excessively low level. Thus, the quantity of the oil to be supplied to the journal bearing 46 becomes sufficient.

As the oil trapped from the rotating member of the crankshaft 22, and retained in the recess portion 37f formed in the upper surface of the intermediate shaft holder 37 is supplied to the lower gear as the lubricating oil through vibration or inclination upon start-up of the engine, The initial lubricating performance is improved.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A transmission shaft support mechanism for a power unit case including a lubricating oil supply mechanism and a gear shaft for supporting a group of gears for power transmission contained therein comprising:
an intermediate shaft holder for supporting an intermediate shaft; and
bolt holes formed in the intermediate shaft holder and an attachment surface of the intermediate shaft holder of the power unit case such that an oil supply passage for lubricating the intermediate shaft is formed to extend in the same direction as the bolt holes.

2. The transmission shaft support mechanism according to claim 1, wherein:
the power unit case includes a journal bearing for supporting a crankshaft;
a main gallery is provided for supplying oil to the journal bearing, said main gallery being provided at a side of the gear shaft of a cylinder to extend toward the crankshaft;
the intermediate shaft holder is provided between the journal bearing and the gear shaft; and
a branch oil passage is formed to supply the oil from the main gallery to the intermediate shaft holder.

3. The transmission shaft support mechanism according to claim 2, wherein an orifice member having an oil passage formed therein is interposed between abutting surfaces of the power unit case and the intermediate shaft holder.

4. The transmission shaft support mechanism according to claim 1, wherein the intermediate shaft holder is provided at a lower portion of a rotating member including the crankshaft, and has a recess portion in its upper surface for trapping and retaining oil droplets.

5. The transmission shaft support mechanism according to claim 1, wherein the intermediate shaft holder includes a first side adapted to be attached to the intermediate shaft holder and a second side includes a recess portion for accommodating an idler gear with a pair of arm portions extending from the first side and forming the recess therebetween.

6. The transmission shaft support mechanism according to claim 5, wherein each of the pair of arm portions includes an intermediate shaft hole for receiving the intermediate shaft and at least one of the pair of arm portions includes a pin hole for fixing the intermediate shaft thereto.

7. The transmission shaft support mechanism according to claim 5, wherein at least one of the pair of arm portions includes the oil supply passage extending from the first side to the intermediate shaft hole and a recess portion for trapping oil droplets is formed in an upper surface of the arm portion that includes the oil supply passage.

8. The transmission shaft support mechanism according to claim 7, and further including a branch oil passage extending from a main gallery to the oil supply passage formed in the intermediate shaft holder for supplying oil thereto.

9. The transmission shaft support mechanism according to claim 1, wherein the oil supply passage is formed to be substantially parallel with the bolt holes.

10. The transmission shaft support mechanism according to claim 8, and further including an orifice member disposed in one of the branch oil passage or the oil supply passage for maintaining a predetermined oil pressure within the oil supply passage.

11. A transmission shaft support mechanism for a power unit case including a lubricating oil supply mechanism and a gear shaft for supporting a group of gears for power transmission contained therein comprising:
an intermediate shaft operatively positioned within said power unit case for supporting a reverse idle gear;
an intermediate shaft holder for supporting said intermediate shaft;
bolt holes formed in the intermediate shaft holder for securing the intermediate shaft holder to the power unit case; and
an oil supply passage formed in the intermediate shaft holder for lubricating the intermediate shaft, said oil supply passage being formed to extend in the same direction as the bolt holes.

12. The transmission shaft support mechanism according to claim 11, wherein:
the power unit case includes a journal bearing for supporting a crankshaft;
a main gallery is provided for supplying oil to the journal bearing, said main gallery being provided at a side of the gear shaft of a cylinder to extend toward the crankshaft;
the intermediate shaft holder is provided between the journal bearing and the gear shaft; and
a branch oil passage is formed to supply the oil from the main gallery to the intermediate shaft holder.

13. The transmission shaft support mechanism according to claim 12, wherein an orifice member having an oil passage formed therein is interposed between abutting surfaces of the power unit case and the intermediate shaft holder.

14. The transmission shaft support mechanism according to claim 11, wherein the intermediate shaft holder is provided at a lower portion of a rotating member including the crankshaft, and has a recess portion in its upper surface for trapping and retaining oil droplets.

15. The transmission shaft support mechanism according to claim 11, wherein the intermediate shaft holder includes a first side adapted to be attached to the intermediate shaft holder and a second side includes a recess portion for accommodating an idler gear with a pair of arm portions extending from the first side and forming the recess therebetween.

16. The transmission shaft support mechanism according to claim 15, wherein each of the pair of arm portions includes an intermediate shaft hole for receiving the intermediate shaft and at least one of the pair of arm portions includes a pin hole for fixing the intermediate shaft thereto.

17. The transmission shaft support mechanism according to claim 15, wherein at least one of the pair of arm portions includes the oil supply passage extending from the first side to the intermediate shaft hole and a recess portion for trapping oil droplets is formed in an upper surface of the arm portion that includes the oil supply passage.

18. The transmission shaft support mechanism according to claim 17, and further including a branch oil passage extending from a main gallery to the oil supply passage formed in the intermediate shaft holder for supplying oil thereto.

19. The transmission shaft support mechanism according to claim 11, wherein the oil supply passage is formed to be substantially parallel with the bolt holes.

20. The transmission shaft support mechanism according to claim 18, and further including an orifice member disposed in one of the branch oil passage or the oil supply passage for maintaining a predetermined oil pressure within the oil supply passage.
